(19) United States
(12) Patent Application Publication
(10) Pub. No.: US 2010/0000369 A1
(43) Pub. Date: Jan. 7, 2010

(54) Method and apparatus for mounting aerodynamic bicycle handlebars

(76) Inventor: Alan Francis Cote, Williston, VT (US)

Correspondence Address: Green Mountain Innovations LLC, P.O.Box 248, Williston, VT, 05495, US

(21) Appl. No.: 12/459,343

(22) Filed: Jun. 30, 2009

Related U.S. Application Data
(60) Provisional application No. 61/133,646, filed on Jul. 1, 2008.

(51) Int. Cl. B62K 21/12; B23P 11/00

(52) U.S. Cl. 74/551.8; 29/428

(57) ABSTRACT

The invention broadly describes a method and apparatus for mounting a handlebar extension assembly to a bicycle's existing handlebars. Such handlebar extensions are typically also used to support a cyclist's elbows and place the cyclist in a narrow, aerodynamic position. In the preferred embodiment, a unshaped handlebar extension attaches to the existing handlebars at two points, with one point to the right of the handlebar stem and the other point to the left of the handlebar stem. The handlebar extension has a third mounting point at the handlebar stem. The third mounting point prevents rotation of the handlebar extension around the primary handlebars. By mounting the extensions at three points, clamping mechanisms that are light in weight and convenient can be used.

### CROSS-REFERENCE TO RELATED APPLICATION: This application claims priority to provisional application No. 61/133,646, filed Jul. 1, 2008

### FEDERALLY-SPONSORED RESEARCH

None

### SEQUENCE LISTING

None

### DOCKET #

Cote6-09

### BACKGROUND OF THE INVENTION

1. Field of the Invention

This application claims priority to provisional application No. 61/133,646, filed Jul. 1, 2008. The present invention relates to the field of bicycle handlebars, and in particular, to aerodynamic-style handlebar extensions, or aerobars. Such aerobars allow a cyclist to place their arms in a position that reduces wind resistance by providing a forward extension to grip, and also usually include a padded support for each elbow or forearm. The present invention offers an improved system for mounting aerobars to the bicycle's primary handlebars.

2. Description of Related Art

Numerous aerobars appear in the patent literature and the marketplace. Commonplace are aerobars that mount to the primary handlebars through the use of two clamps, with one clamp on each side or end of the aerobar. Numerous variations on this basic design exist.

Also existing is prior art for aerobars which clamp solely to the handlebar stem, with no clamps that contact the primary handlebar. An example of this is the Sarkbar, marketed in the 1980s.

Additional designs exist in the market for aerobars that mount directly to the faceplate of the handlebar stem, the faceplate being a removable clamping piece that's part of the stem, and used to secure the primary handlebars to the stem. The faceplate systems use assorted styles of dedicated, specialized faceplates that provide an interface for mounting aerobars.

Also existing are one-piece designs, in which the aerobar and primary handlebar are formed as one unit, with no clamps required. Such designs offer the benefit of no possibility of a separable aerobar slipping or rotating, however such one-piece designs limit the adjustments to the position of the aerobars relative to the primary handlebars.

Conventional aerobars that mount to the primary handlebars with two clamps, face many limitations. Because these clamps must be cinched very tightly in order to prevent slippage of the aerobars relative to the primary handlebars, the clamps must be made of relatively strong material such as aluminum, and the clamps must be secured with bolts. A tool such as a wrench is required to cinch the bolts and thus securely mount the aerobars. A further complication is that the primary handlebars are typically covered with padded tape to protect the cyclist's hands, and cables for brakes and shifters often are wrapped under the tape against the primary handlebars. A section of both the tape and the cables must be removed from the primary handlebars in order to provide an unobstructed section of the primary handlebars for the aerobar clamps to mount.

Additionally, primary handlebars made of composite materials such as carbon fiber are not designed to be tightly cinched by traditional aerobar clamps, with many manufacturers of such composite primary handlebars expressly forbidding such practice due to the potential for the clamps to crush the handlebars or create notches/gouges, either of which could lead to sudden catastrophic failure of the primary handlebars.

Even when the clamps of conventional aerobars are cinched tightly, it is still possible that the position of the aerobars relative to the primary handlebars may change due to clamp slippage. This is due to the long effective lever arm provided by the cantilever configuration of aerobars, and the round cross section of primary handlebars. Clamp slippage can occur when a cyclist hits a bump in the road, suddenly increasing the peak load on the aerobars and clamps.

What is needed, therefore, is an aerobar mounting system in which the aerobars do not depend solely on clamping pressure to secure their position relative to the primary handlebars. Related needs are a design which requires such lower clamping pressure to enable lighter weight clamping materials, toolless installation, elimination of the need to remove tape or cables from the primary handlebars, and the option of mounting aerobars to primary handlebars made of composites such as carbon fiber.

### BRIEF SUMMARY OF THE INVENTION

The present invention improves on previous art by employing a new style mounting system for attaching the aerobars to the primary handlebars. Most existing aerobars are attached to the primary handlebars with two clamps, with one clamp on each side or end of the aerobars. Such clamps typically are made of metal. These clamps must be very tightly secured to the primary handlebars to prevent the aerobars from rotating or slipping relative to the primary handlebars.

As will be explained in greater detail, the present invention attaches the aerobars to the steering assembly of the bicycle at both the primary handlebars and at the handlebar stem. In the preferred embodiment, two of the attachment points are located in the traditional locations where existing aerobars attach to the primary handlebars. In addition, the present invention uses a third mounting point at the handlebar stem of the bicycle. By using a third mounting point, the aerobars are prevented from slipping or rotating relative to the primary handlebars through triangulation, with the inherent bracing of this configuration preventing such rotation or slipping. This permits the clamping force at each mounting point to be greatly reduced compared to the previous two-clamp systems. This affords numerous benefits, including: ease of installation, a lighter-duty clamp for cost and weight savings, greatly reduced likelihood of unwanted rotation or slipping of the aerobar, and other benefits of reduced clamping force which are detailed below.

The design of the mounting system also allows, if desired, the elimination of one of the two mounts between the aerobars and the primary handlebars, due to the inherent resistance to rotation of the aerobars relative to the primary handlebars that the design provides. Aerobar designs with a single forward arm extension tube, whose end is punctuated with a T, Y, or other suitable shape for two hands to grasp, are well known in the art. Incorporating the handlebar and stem mounting points of the present invention with a single forward arm extension design can easily be accomplished as well under this claimed invention.

### BRIEF DESCRIPTION OF THE SEVERAL FIGURES

The description of the design will become more clear and apparent when reviewed in conjunction with the accompanying drawings.

FIG. 1 shows a perspective view of the preferred embodiment of the inventive aerobar assembly, including the primary handlebars to which the inventive aerobars attach.

FIG. 2 shows a perspective view an alternate embodiment of the aerobar assembly, including the primary handlebars to which the inventive aerobars attach.

FIG. 3 shows a close-up of the engagement means used in the preferred embodiment.

Specific components referred to in the FIGs are as follows:
10: primary handlebars
20: aerobars
30a: left engagement means
30b: right engagement means
35: bolts
37: engagement means hinge
38: engagement means cinch bolt
39: engagement means cinch nut
40: handlebar stem
45: stem-to-primary-handlebars clamp
50: rear engagement means
60: spacers

### DETAILED DESCRIPTION OF THE INVENTION

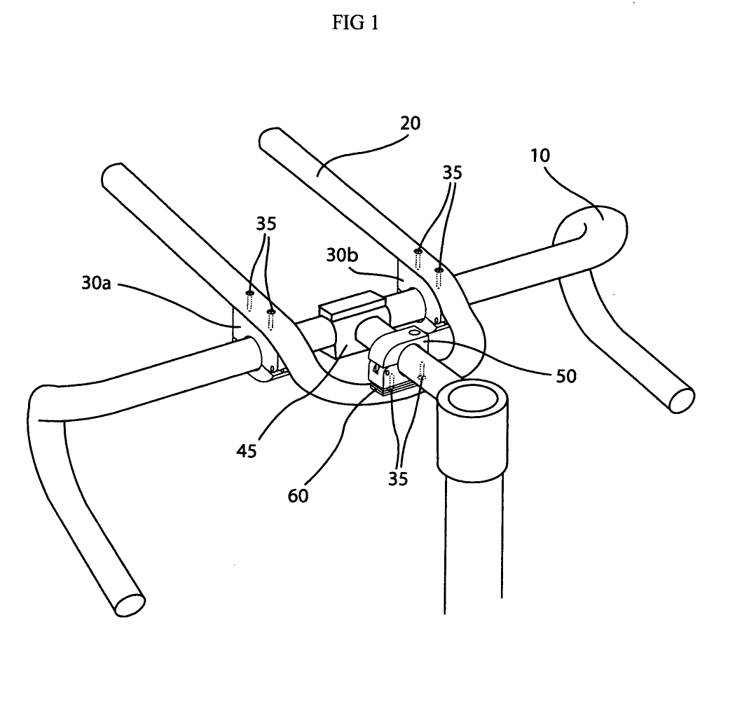

The invention is further understood by reference to the illustrations. FIG. 1 shows the inventive aerobar assembly installed to a set of primary handlebars.

Aerobars 20 form the extension which a cyclist grasps with each hand, placing the cyclist in streamlined body position with arms forward and narrow. Aerobars 20 are made of aluminum, carbon fiber, or other suitable material. There is typically one armrest associated with each arm extension, on which the cyclist rests their elbow or forearm. Such armrests can readily be included with the invention, but are not shown in order to better illustrate the new and innovative features of this inventive design. Armrests may mount directly to the arm extensions, mount directly to the handlebars, or in any number of the manners already known in the art.

The inventive aerobar assembly is shown mounted to primary handlebars 10. The primary handlebars are mounted to a conventional handlebar stem, or simply stem, 45. The stem 45 is secured to the primary handlebars by stem clamp 50.

Aerobars 20 are engaged to the primary handlebars 10 with engagement means 30a and 30b. In the preferred embodiment, 30a and 30b are adjustable light-duty plastic clamps, molded of a material such as Zytel. 30a and 30b are attached directly and permanently to the aerobars, using fasteners such as bolts 35. Other suitable means for attaching 35a and 35b to aerobars 20 include but are not limited rivets, bonding, or 35a and 35b could be co-molded as one piece with aerobars 20. A third engagement means 50 is incorporated into the aerobars 20 and permanently mounted to the aerobars 20 using bolts 35. Engagement means 50 removabel mounts to stem 40. Engagement means 50 may be of the same or a different type as 35a and 35b. Spacers 60 can be used in conjunction with engagement means 50 to adjust the angle of aerobars 20 relative to horizontal. A different number of spacers allows aerobars' 20 angle to be changed, as needed by different models of stems, and to allow a cyclist to place aerobars 10 at her preferred angle.

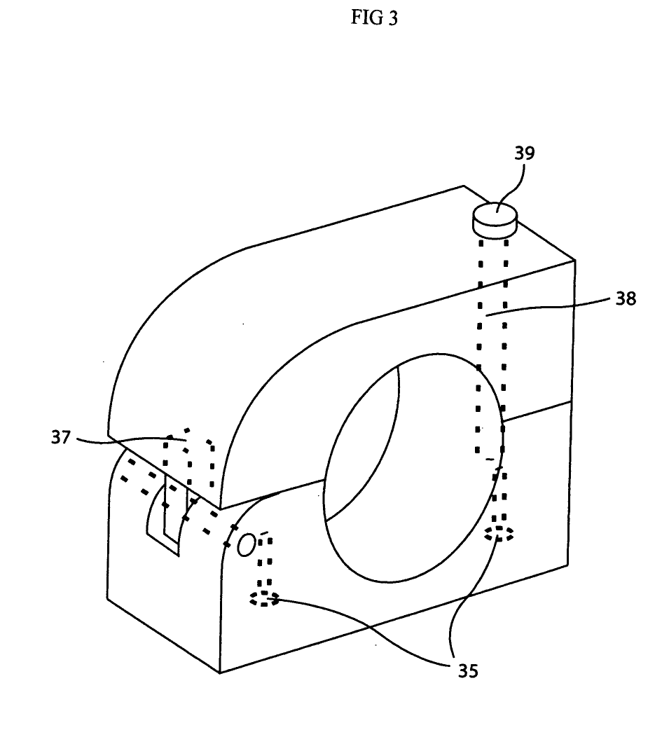

The purpose of engagement means 35a, 35b, and 50 is to attach aerobar 20 to primary handlebars 10 and stem 40, respectively. As shown in the preferred embodiment, and in FIG. 3, the engagement means compromise a hinged-type clamp. The clamps are capable of opening and wrapping around the primary handlebars 10 and stem 40 with hinge 37 providing pivotability. The clamps are then secured in a closed position with a fastener such as cinch bolt 38 and cinch nut 39. Cinch nut 39 can be the type turned by a wrench or a tool-less type such as a thumb knob or wingnut. The hinged-type clamp allows the user to quickly and easily install or remove aerobars 20 to the primary handlebars 10.

In the preferred embodiment, the rearward section of aerobars 20 curves downward to pass underneath stem 40. This provides inherent resistance to downward force applied to the forward end the aerobars 20. Such downward force occurs for instance when a cyclist's hands are pressing downward at the forward end of the aerobars 20, or when the cyclist rides over a bump on the pavement. By configuring aerobars 20 to pass underneath stem 40, downward rotation of the aerobars 40 around the primary handlebars 10 is not possible, even if engagement means 30a, 30b, or 50 were to be inadvertently left in a loose, unsecured position.

The inventive elements presented, regardless of different aerobar configurations, include the securing of the aerobars to both the handlebars and to the stem. Because the stem is positioned rearward of the primary handlebars, attaching aerobars to the stem as well as the primary handlebars results in a natural bracing against rotation. In conventional designs, this rotation is prevented solely by the clamping pressure of the aerobars to the primary handlebars. With the inventive design the clamping pressure at one or more positions on the primary handlebars can be minimal. The requirement of minimal clamping pressure means that the invention can be used with carbon fiber handlebars that would be damaged by the higher clamping pressure required by conventional aerobar clamps. Likewise, the engagement means 30a and 30b can even be mounted on top of the soft padded tape that is usually wrapped on bicycle handlebars, eliminating the cumbersome task of unwrapping a section of tape to expose the bare handlebars before aerobars can be installed. Engagement means 30a and 30b alone are not sufficient by themselves to secure the aerobars 20 to the primary handlebars 10, as 30a and 30b don't create enough clamping pressure to prevent unwanted rotation of the aerobars 20 around primary handlebars 10. However, when used with a rearward clamp 50 to the stem 40, a secure and steady attachment system for aerobars is realized.

While FIG. 1 shows the preferred embodiment of the design, the invention should in no way be construed as limited to this specific configuration. Numerous variations of the design can be implemented. The inventive elements, which can be common to many different possible executions, are those which secure the aerobars 20 to both the primary handlebars 10 and to the stem 40, thereby allowing a secure mounting system with a minimal of clamping pressure at each mounting point.

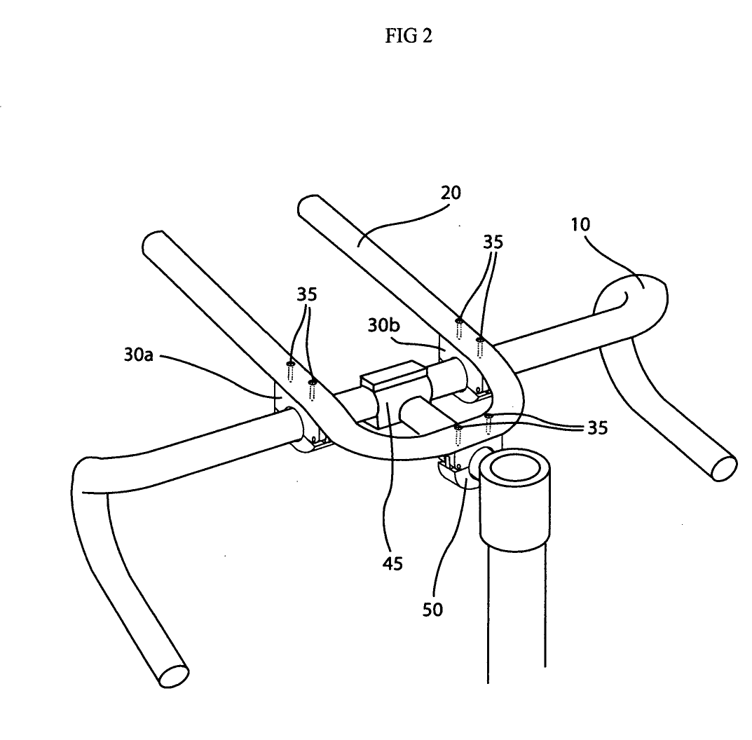

An alternate embodiment is shown in FIG. 2, in which aerobars 20 do not curve underneath stem 40. There are numerous combinations for mounting aerobars 20 to both the primary handlebars 10 and stem 40 which results in a 3-point mounting system. For instance, aerobars 20 can mount to the underside of primary bars 10, with the end of aerobars 20 curving upward over the top of stem 40. Likewise, the end of aerobars 20 need not curve upward, and the entire aerobar 20 can mount to the bottom side of primary handlebars 10 and stem 40. Another embodiment comprises an aerobar made from two individual tubes and a rear mounting bracket. The tubes include engagement means such as 30a and 30b to the primary handlebars 10. The rearward end of each tube mounts to an endbracket, with the end bracket including an engagement means for attaching to the stem 40. This style assembly can be mounted either above or below the primary handlebars 10. It should also be noted that such an endbracket could be executed in many different fashions. Rather than being a separate bracket into which the two tubes mount, the endbracket could readily be formed as an integral part of either or both individual tubes. In these designs, endbracket 7 or its equivalent could pass either under stem 4 or above stem 4. Likewise, brackets of many different shapes and sizes can readily be designed by those skilled in the art. Another embodiment of the invention uses an aerobar with a single forward extension tube, whose forward end punctuates with a T, Y, or other suitable shape for two hands to grasp. Using this configuration, a single left or right engagement means such as 30a or 30b can be used. With this configuration, engagement means 40 is utilized to create the rear bracing that prevents unwanted rotation of the aerobar around the primary handlebars 40 with minimal clamping pressure. Regardless of the exact configuration, the inventive design describes a system in which a portion of the arm extensions, or a bracket they attach to, are attached to the handlebar stem to help create a secure mounting.

Similarly, the engagement means 30a, 30b and 50 shown in the preferred embodiment may easily be substituted with other appropriate means of engagement. Means for such engagement include, but are not limited to, other styles of wrap-around clamps; hook and loop straps; straps and buckles (such as cam buckles); ratcheting buckles; u-bolts; zipties; wormgear-type fasteners, and more primitive methods such as wirebanding and twine.

What is claimed:

1. An assembly for mounting a bicycle handlebar extension assembly to primary bicycle handlebars comprising:
at least one primary engagement means for attaching said extension assembly to said primary handlebars;
at least one secondary engagement means for attaching said aerobar assembly to the handlebar stem;
whereby said secondary engagement means prevents said extension from rotating around said primary handlebars.

2. The apparatus of claim 1 in which the engagement means are c-shaped flexible clamps, with each said clamp cinched by a bolt.

3. The apparatus of claim 1 in which the engagement means are hinged clamps, with each said clamp cinched by a bolt.

4. The apparatus of claim 1 in which the engagement means are worm-gear style clamps.

5. The apparatus of claim 1 in which said extension mounts to the top-side of said primary handlebars.

6. The apparatus of claim 1 in which said extension mounts to the bottom-side of said primary handlebars.

7. The apparatus of claim 1 in which said extension is U-shaped.

8. The apparatus of claim 1 which includes two primary engagement means, with one primary engagement means mounting to the right of the handlebar stem, and the other primary engagement means mounting to the left of the handlebar stem.

9. The apparatus of claim 1 which includes one primary engagement means, with said primary engagement means mounting to the primary handlebars either to the left or to the right of the handlebar stem.

10. A method for mounting a bicycle handlebar extension assembly to primary bicycle handlebars comprising the steps of:
attaching said extension assembly to said primary handlebars through one or more engagement means;
attaching said extension assembly to the handlebar stem through one or more engagement means;
whereby said secondary engagement means prevents said extension from rotating around said primary handlebars.

11. The method of claim 10 in which the engagement means are c-shaped flexible clamps, with each said clamp cinched by a bolt.

12. The apparatus of claim 10 in which the engagement means are hinged clamps, with each said clamp cinched by a bolt.

13. The apparatus of claim 10 in which the engagement means are worm-gear style clamps.

14. The apparatus of claim 10 in which said extension mounts to the top-side of said primary handlebars.

15. The apparatus of claim 10 in which said extension mounts to the bottom-side of said primary handlebars.

16. The apparatus of claim 10 in which said extension is U-shaped.

17. The apparatus of claim 10 which includes two primary engagement means, with one primary engagement means mounting to the right of the handlebar stem, and the other primary engagement means mounting to the left of the handlebar stem.

19. The apparatus of claim 10 which includes one primary engagement means, with said primary engagement means mounting to the primary handlebars either to the left or to the right of the handlebar stem.
